(19) United States
(12) Patent Application Publication
(10) Pub. No.: US 2025/0074049 A1
(43) Pub. Date: Mar. 6, 2025

(54) METHOD OF INKJET PRINTING AND INKJET PRINTING DEVICE

(71) Applicant: Samsung Display Co., LTD., Yongin-si (KR)

(72) Inventors: SATOSHI TOMOEDA, Yongin-si (KR); Setsu Takeuchi, Yongin-si (KR); JONGKIL HAN, Yongin-si (KR); MYUNGSOO HUH, Yongin-si (KR)

(73) Assignee: Samsung Display Co., LTD., Yongin-si (KR)

(21) Appl. No.: 18/820,723

(22) Filed: Aug. 30, 2024

(30) Foreign Application Priority Data
Aug. 31, 2023 (KR) 10-2023-0115599

(51) Int. Cl. B41J 2/045

(52) U.S. Cl. CPC B41J 2/04588; B41J 2/0457; B41J 2/04573; B41J 2/04581

(57) ABSTRACT

A method of inkjet printing includes applying a driving signal to a head through a controller, the head including nozzles, driving the head in response to the driving signal, and applying a first control signal that changes a driving waveform of the driving signal to the head through the controller.

### CROSS-REFERENCE TO RELATED APPLICATION(S)

This application claims priority to and benefits of Korean Patent Application No. 10-2023-0115599 under 35 USC § 119 filed on Aug. 31, 2023, in the Korean Intellectual Property Office, the entire contents of which are incorporated herein by reference.

### BACKGROUND

### 1. Technical Field

Embodiments relate to a method of inkjet printing. Embodiments relate to a method of inkjet printing and an inkjet printing device for performing the method.

### 2. Description of the Related Art

A print head of an inkjet printing device may include a plurality of nozzles and a plurality of piezoelectric elements corresponding to the plurality of nozzles. Here, the piezoelectric element refers to an element that changes its shape by generating pressure in case that voltage is applied.

In case that printing data is given to the inkjet printing device, voltage may be applied to each of the piezoelectric elements included in the print head corresponding to the printing data. The piezoelectric element to which the voltage is applied may discharge ink built in the print head through the nozzle while a portion of the piezoelectric element protrudes.

It is to be understood that this background of the technology section is, in part, intended to provide useful background for understanding the technology. However, this background of the technology section may also include ideas, concepts, or recognitions that were not part of what was known or appreciated by those skilled in the pertinent art prior to a corresponding effective filing date of the subject matter disclosed herein.

### SUMMARY

Embodiments provide a method of inkjet printing with improved efficiency.

Embodiments provide an inkjet printing device performing the method of inkjet printing.

A method of inkjet printing according to an embodiment may include applying a driving signal through a controller to a head, the head including a plurality of nozzles, driving the head in response to the driving signal, and applying a first control signal that changes a driving waveform of the driving signal to the head through the controller.

In an embodiment, in the applying of the first control signal to the head through the controller, a third control signal that designates the driving signal may be applied to the head through the controller.

In an embodiment, the controller may include discharge data for each of the plurality of nozzles, and in the applying of the first control signal to the head through the controller, the driving waveform may be changed using the discharge data.

In an embodiment, the method may further include applying a second control signal that changes a voltage setting of the driving waveform to the head through the controller.

In an embodiment, in the applying of the second control signal to the head through the controller, the third control signal may be applied to the head through the controller.

In an embodiment, in the applying of the second control signal to the head through the controller, a time during which voltage is applied may be changed using the discharge data.

In an embodiment, in the applying of the second control signal to the head through the controller, the voltage setting of the driving waveform may be changed using the discharge data.

In an embodiment, in the applying of the second control signal to the head through the controller, n discharge data may be used among the discharge data, where n is a natural number, and a voltage of the driving waveform may be changed to a value obtained by dividing a maximum level of the voltage by 2^{m}), where m is an integer greater than or equal to 0 and less than or equal to n.

In an embodiment, in the applying of the second control signal to the head through the controller, n discharge data may be used among the discharge data, where n is a natural number, the n discharge data may include data units each including m discharge data, where m is a natural number that is a divisor of n, a voltage of the driving waveform may be changed using k discharge data included in each of the data units, where k is a natural number less than m, and a time may be set using (m−k) discharge data included in each of the data units.

In an embodiment, the discharge data may include the first control signal, the second control signal, and the third control signal.

In an embodiment, in the applying of the driving signal to the head through the controller and in the driving of the head, the first control signal and the second control signal may not be applied to the head.

In an embodiment, in the applying of the first control signal to the head through the controller and in the applying of the second control signal to the head through the controller, the driving signal may not be applied to the head.

An inkjet printing device according to an embodiment may include a head including a plurality of nozzles, and a controller that applies a driving signal or a first control signal that changes a driving waveform of the driving signal to the head.

In an embodiment, the controller may simultaneously apply the first control signal and a third control signal that designates the driving signal to the head.

In an embodiment, the controller may include discharge data for each of the plurality of nozzles, and may change the driving waveform using the discharge data.

In an embodiment, the controller may apply the driving signal, the first control signal, or a second control signal that changes a voltage setting of the driving waveform to the head.

In an embodiment, the controller may simultaneously apply the second control signal and the third control signal to the head.

In an embodiment, the controller may change a time during which voltage is applied using the discharge data.

In an embodiment, the controller may change the voltage setting of the driving waveform using the discharge data.

In an embodiment, the controller may use n discharge data among the discharge data, where n is a natural number, and may change a voltage of the driving waveform to a value obtained by dividing a maximum level of the voltage by 2^{m}, where m is an integer greater than or equal to 0 and less than or equal to n.

In an embodiment, the controller may use n discharge data among the discharge data, where n is a natural number, the n discharge data may include data units each including m discharge data, where m is a natural number that is a divisor of n, and the controller may change a voltage of the driving waveform using k discharge data included in each of the data units, where k is a natural number less than m, and may set a time using (m−k) discharge data included in each of the data units.

In an embodiment, the discharge data may include the first control signal, the second control signal, and the third control signal.

In a method of inkjet printing according to embodiments, the method may be performed using an inkjet printing device including a controller that applies discharge data and a control signal to a head. The control signal may include a first control signal that changes a driving waveform of a driving signal, a second control signal that changes a voltage setting of the driving waveform of the driving signal, and a third control signal that designates the driving signal.

In case that it is desirable to change the driving waveform, since the driving waveform may be changed using data of the controller, a separate configuration for changing the driving waveform may not be required. Since it is not desirable to stop printing to change the driving waveform, changing the driving waveform may be performed regardless of a time point, such as in case that printing starts, during printing, in case that printing is completed, in case that changing to a target substrate having a different size, or the like within the spirit and the scope of the disclosure. Accordingly, efficiency of printing using the inkjet printing device may be improved.

### BRIEF DESCRIPTION OF THE DRAWINGS

The above and other aspects and features of the disclosure will become more apparent by describing in detail embodiments thereof with reference to the attached drawings, in which:

FIG. 1 is a schematic perspective view illustrating an inkjet printing device according to an embodiment.

FIG. 2 is a view illustrating a head and data included in a controller included in the inkjet printing device of FIG. 1.

FIGS. 3 and 4 are views illustrating a third control signal included in the data of FIG. 2.

FIGS. 5, 6, 7, 8, 9, and 10 are views illustrating a method of inkjet printing according to an embodiment.

FIGS. 11 and 12 are views illustrating an inkjet printing device according to an embodiment.

### DETAILED DESCRIPTION OF THE EMBODIMENTS

Hereinafter, embodiments of the disclosure will be described in more detail with reference to the accompanying drawings. The same reference numerals are used for the same components in the drawings, and redundant descriptions of the same components may be omitted.

In the drawings, sizes, thicknesses, ratios, and dimensions of the elements may be exaggerated for ease of description and for clarity. Like numbers refer to like elements throughout.

As used herein, the singular forms, “a,” “an,” and “the” are intended to include the plural forms as well, unless the context clearly indicates otherwise.

In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.”

In the specification and the claims, the phrase “at least one of” is intended to include the meaning of “at least one selected from the group of” for the purpose of its meaning and interpretation. For example, “at least one of A and B” may be understood to mean “A, B, or A and B.”

It will be understood that, although the terms first, second, etc., may be used herein to describe various elements, these elements should not be limited by these terms. These terms are only used to distinguish one element from another element. For example, a first element may be referred to as a second element, and similarly, a second element may be referred to as a first element without departing from the scope of the disclosure.

The spatially relative terms “below”, “beneath”, “lower”, “above”, “upper”, or the like, may be used herein for case of description to describe the relations between one element or component and another element or component as illustrated in the drawings. It will be understood that the spatially relative terms are intended to encompass different orientations of the device in use or operation, in addition to the orientation depicted in the drawings. For example, in the case where a device illustrated in the drawing is turned over, the device positioned “below” or “beneath” another device may be placed “above” another device. Accordingly, the illustrative term “below” may include both the lower and upper positions. The device may also be oriented in other directions and thus the spatially relative terms may be interpreted differently depending on the orientations.

The terms “overlap” or “overlapped” mean that a first object may be above or below or to a side of a second object, and vice versa. Additionally, the term “overlap” may include layer, stack, face or facing, extending over, covering, or partly covering or any other suitable term as would be appreciated and understood by those of ordinary skill in the art.

The terms “face” and “facing” mean that a first element may directly or indirectly oppose a second element. In a case in which a third element intervenes between the first and second element, the first and second element may be understood as being indirectly opposed to one another, although still facing each other.

When an element is described as ‘not overlapping’ or ‘to not overlap’ another element, this may include that the elements are spaced apart from each other, offset from each other, or set aside from each other or any other suitable term as would be appreciated and understood by those of ordinary skill in the art.

The terms “comprises,” “comprising,” “includes,” and/or “including,”, “has,” “have,” and/or “having,” and variations thereof when used in this specification, specify the presence of stated features, integers, steps, operations, elements, components, and/or groups thereof, but do not preclude the presence or addition of one or more other features, integers, steps, operations, elements, components, and/or groups thereof.

The phrase “in a plan view” means viewing the object from the top, and the phrase “in a schematic cross-sectional view” means viewing a cross-section of which the object is vertically cut from the side.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Unless otherwise defined or implied herein, all terms (including technical and scientific terms) used herein have the same meaning as commonly understood by one of ordinary skill in the art to which the disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that when an element (or a region, a layer, a portion, or the like) is referred to as “being on”, “connected to” or “coupled to” another element in the specification, it can be directly disposed on, connected or coupled to another element mentioned above, or intervening elements may be disposed therebetween.

It will be understood that the terms “connected to” or “coupled to” may include a physical or electrical connection or coupling.

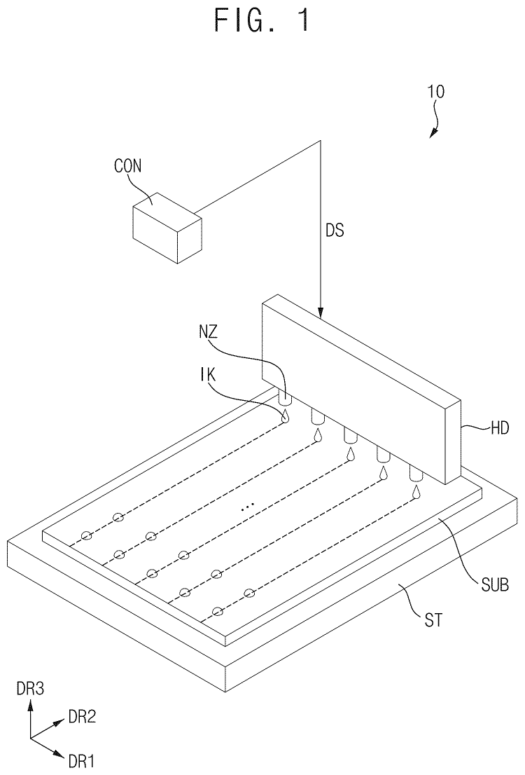

FIG. 1 is a schematic perspective view illustrating an inkjet printing device according to an embodiment.

Referring to FIG. 1, an inkjet printing device 10 may include a head HD and a controller CON. The inkjet printing device 10 may be disposed on a stage ST.

The stage ST may be parallel to a plane defined by a first direction DR1 and a second direction DR2 intersecting the first direction DR1. For example, the first direction DR1 and the second direction DR2 may be perpendicular to each other.

The stage ST may support a target substrate SUB. An ink IK may be deposited on the target substrate SUB to form a pattern.

The head HD may be spaced apart from the stage ST in a third direction DR3 intersecting each of the first direction DR1 and the second direction DR2. For example, the third direction DR3 may be perpendicular to each of the first direction DR1 and the second direction DR2.

The head HD may discharge the ink IK onto the target substrate SUB disposed on the stage ST. The head HD may include a plurality of nozzles NZ that discharge the ink IK in a direction opposite to the third direction DR3 toward the target substrate SUB. For example, the nozzles NZ may be arranged or disposed in the first direction DR1.

The head HD may move along the second direction DR2. The head HD may move in the second direction DR2 and discharge the ink IK onto the target substrate SUB. For example, the head HD may discharge the ink IK in a stationary state, and may move a selectable distance in the second direction DR2 and discharge the ink IK again in a stationary state. However, the disclosure is not limited thereto, and the head HD may repeatedly discharge the ink IK while moving.

The ink IK discharged on the target substrate SUB may be cured to form the pattern. The ink IK discharged from the head HD may form the pattern in the first direction DR1 and the second direction DR2.

The controller CON may control driving of the head HD. The controller CON may apply (or output) a driving signal DS to the head HD. The driving signal DS may include information regarding discharge of the ink IK. The driving signal DS may be a driving waveform. The head HD may be driven in response to the driving signal DS.

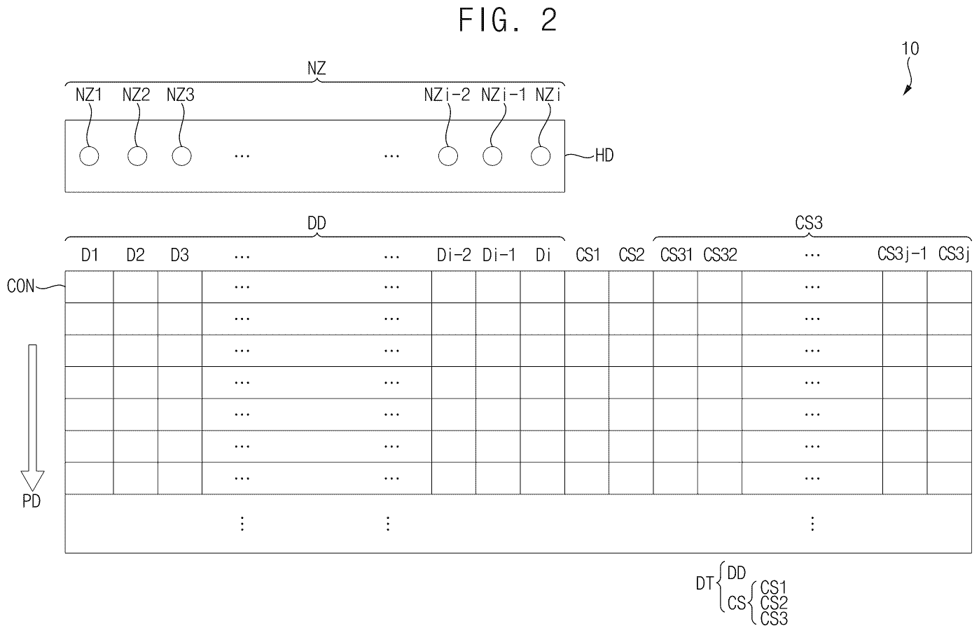

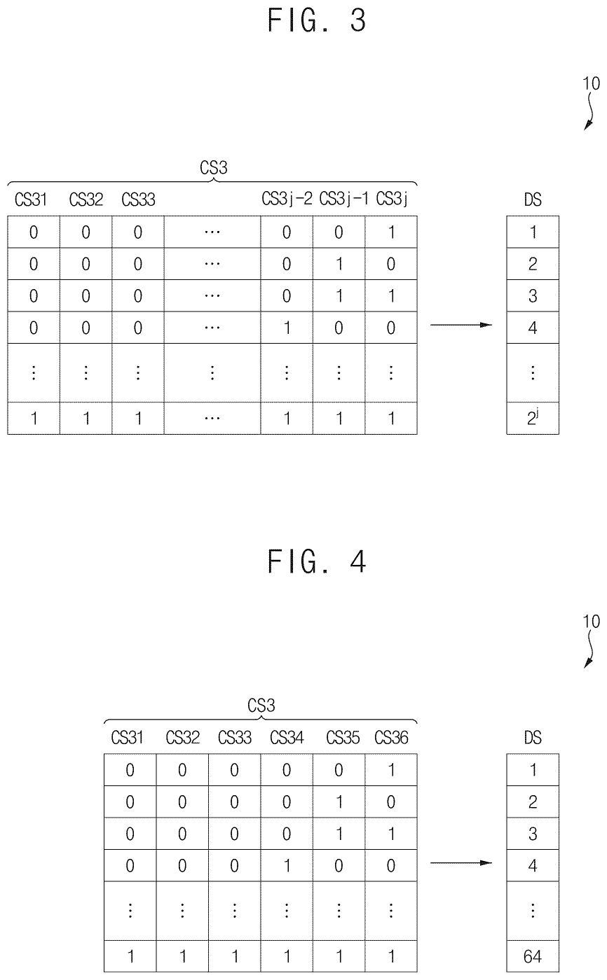

FIG. 2 is a view illustrating a head and data included in a controller included in the inkjet printing device of FIG. 1. FIGS. 3 and 4 are views illustrating a third control signal included in the data of FIG. 2.

Referring to FIGS. 1, 2, 3, and 4, the inkjet printing device 10 may include the head HD and the controller CON.

The head HD may include the plurality of nozzles NZ. For example, the head HD may include first to i-th (where i is a natural number) nozzles NZ1 to NZi. Each of the first to i-th nozzles NZ1 to NZi may discharge the ink IK.

The controller CON may include data DT. The controller CON may apply (or output) the data DT to the head HD. The data DT may be expressed as a binary value of “0” or “1”. The data DT may include discharge data DD and a control signal CS.

The discharge data DD may be data that controls discharge of the ink IK of each of the nozzles NZ. The discharge data DD may include first to i-th discharge data D1 to Di that control whether the first to i-th nozzles NZ1 to NZi discharge the ink IK, respectively. The first to i-th discharge data D1 to Di may correspond to the first to i-th nozzles NZ1 to NZi, respectively. For example, the i-th discharge data Di may control the discharge of the ink IK of the i-th nozzle NZi. The first to i-th discharge data D1 to Di may control operations of the first to i-th nozzles NZ1 to NZi along a printing direction PD, respectively.

In case that the driving signal DS is applied to the head HD from the controller CON, the head HD may be driven in response to the driving signal DS. In this case, the first to i-th nozzles NZ1 to NZi of the head HD may discharge the ink IK or may not discharge the ink IK in response to the first to i-th discharge data D1 to Di, respectively.

The control signal CS may be data that controls an operation of the head HD. In an embodiment, the control signal CS may not be included in the discharge data DD, and may be data separate from the discharge data DD. The control signal CS may include a first control signal CS1, a second control signal CS2, and a third control signal CS3.

In an embodiment, the first control signal CS1 may be a signal that changes a driving waveform of the driving signal DS. The second control signal CS2 may be a signal that changes a voltage setting of the driving waveform of the driving signal DS.

For example, in case that the first control signal CS1 is “1” and the second control signal CS2 is “0”, the driving waveform may be changed. In case that the first control signal CS1 is “0” or “1”, and the second control signal CS2 is “1”, the voltage setting of the driving waveform may be changed.

In an embodiment, in case that at least one of the first control signal CS1 and the second control signal CS2 is “1”, the head HD may not be driven. For example, in case that the first control signal CS1 or the second control signal CS2 is “1”, the ink IK may not be discharged. In case that each of the first control signal CS1 and the second control signal CS2 is “0”, the head HD may be driven to discharge the ink IK.

The third control signal CS3 may be a signal that designates the driving signal DS in which the driving waveform is changed by the first control signal CS1 or the voltage setting is changed by the second control signal CS2. For example, the third control signal CS3 may be a signal that designates a number of the driving waveform.

The third control signal CS3 may include first to j-th (where j is a natural number) number data CS31 to CS3j. The driving signal DS may be designated according to a binary value of each of the first to j-th number data CS31 to CS3j. For example, the driving signal DS may be designated by a j-bit binary number.

For example, in case that the third control signal CS3 may include the first to sixth number data CS31 to CS36, the driving signal DS may be designated by a 6-bit binary number. For example, in case that the third control signal CS3 is “000100”, the driving waveform of the driving signal DS may be a fourth driving waveform (see FIG. 4).

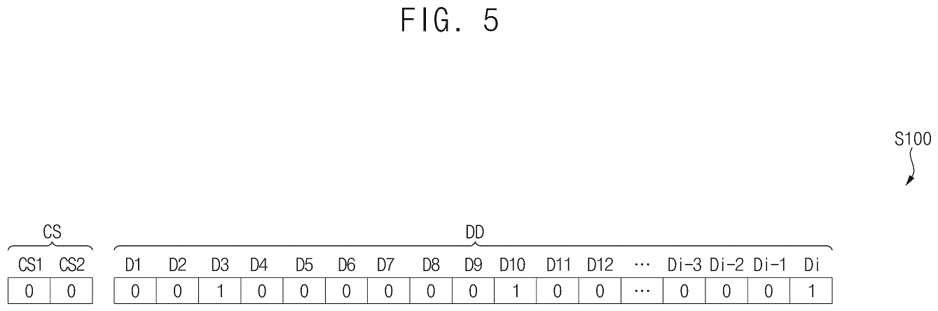

FIGS. 5, 6, 7, 8, 9, and 10 are views illustrating a method of inkjet printing according to an embodiment.

For example, the method of inkjet printing described with reference to FIGS. 5, 6, 7, 8, 9, and 10 may be performed using the inkjet printing device 10 described with reference to FIGS. 1, 2, 3, and 4. Therefore, redundant descriptions may be omitted or simplified.

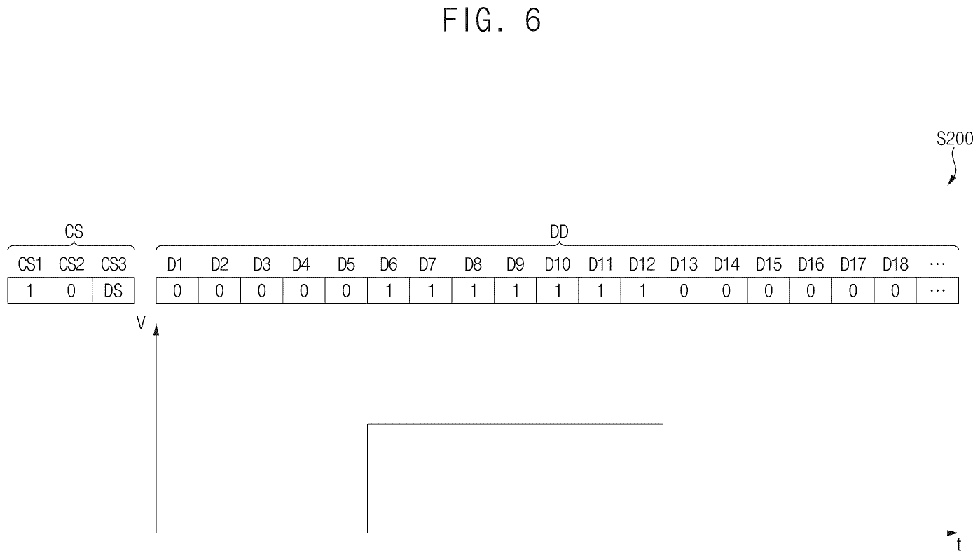

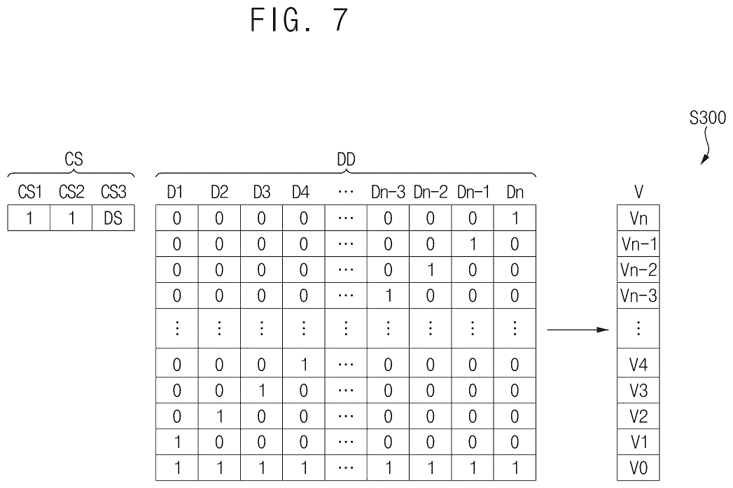

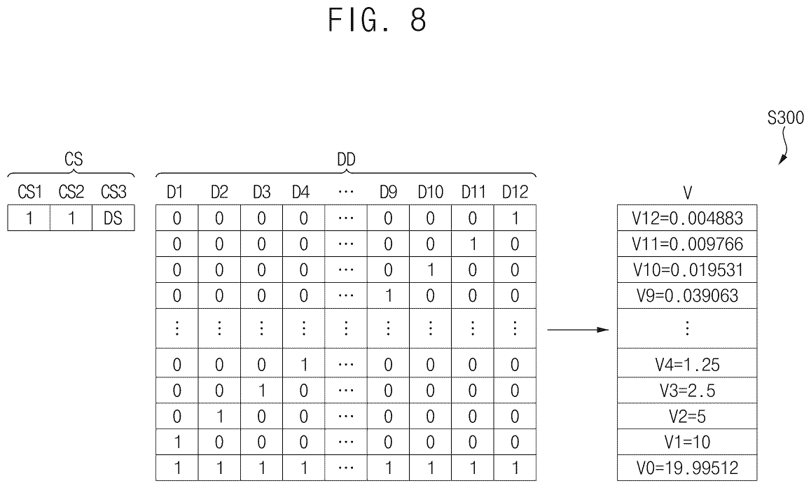

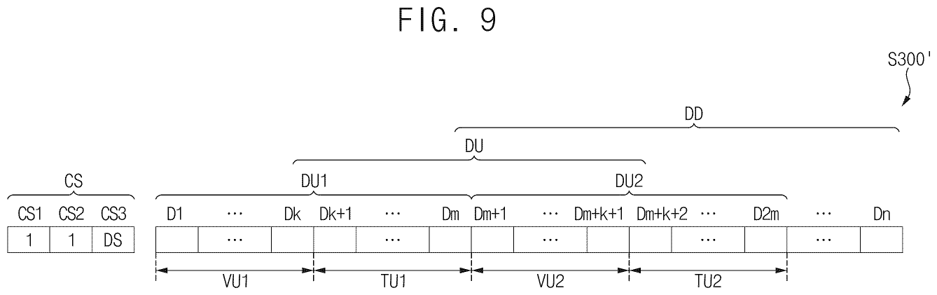

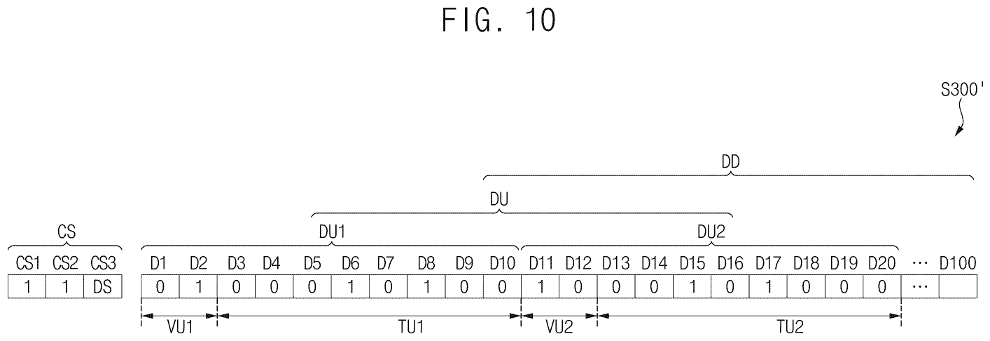

For example, FIG. 5 may be a view illustrating a step (S100) of applying the driving signal DS to the head HD through the controller CON, and FIG. 6 may be a view illustrating a step (S200) of applying the first control signal CS1 to the head HD through the controller CON as a function of voltage V and time t. FIGS. 7 and 8 are views illustrating an example of a step (S300) of applying the second control signal CS2 to the head HD through the controller CON, and FIGS. 9 and 10 may be views illustrating another example of a step (S300′) of applying the second control signal CS2 to the head HD through the controller CON.

Referring to FIGS. 1, 2, and 5, the controller CON may apply the driving signal DS to the head HD (S100).

The head HD may be driven in response to the driving signal DS. In an embodiment, while the head HD is being driven, each of the first control signal CS1 and the second control signal CS2 may not be applied to the head HD. For example, each of the first control signal CS1 and the second control signal CS2 may be “0”.

In case that the first to i-th discharge data D1 to Di are “1”, the first to i-th nozzles NZ1 to NZi corresponding to the first to i-th discharge data D1 to Di may discharge the ink IK, respectively. In case that the first to i-th discharge data D1 to Di are “0”, the first to i-th nozzles NZ1 to NZi corresponding to the first to i-th discharge data D1 to Di may not discharge the ink IK, respectively.

For example, in case that only the third discharge data D3, the tenth discharge data D10, and the i-th discharge data Di are “1”, each of the third nozzle NZ3, the tenth nozzle NZ10, and the i-th nozzle NZi may discharge the ink IK, and other nozzles may not discharge the ink IK (see FIG. 5).

Referring to FIGS. 1, 2, and 6, the controller CON may apply the first control signal CS1 that changes the driving waveform of the driving signal DS to the head HD (S200).

The controller CON may simultaneously apply the first control signal CS1 and the third control signal CS3 to the head HD. As the first control signal CS1 is applied to the head HD, the head HD may not be driven.

In an embodiment, the driving waveform of the driving signal DS may be changed by using the discharge data DD. For example, in case that the first to i-th discharge data D1 to Di are used and each of the first to i-th discharge data D1 to Di is defined as about 0.1 μsec, a driving waveform of (0.1*i) usec may be generated.

Accordingly, the driving waveform of the driving signal DS designated by the third control signal CS3 may be changed into a driving waveform generated using the discharge data DD.

Referring to FIGS. 1, 2, 7, and 8, the controller CON may apply the second control signal CS2 that changes the voltage setting of the driving waveform to the head HD (S300).

The controller CON may simultaneously apply the second control signal CS2 and the third control signal CS3 to the head HD. As the second control signal CS2 is applied to the head HD, the head HD may not be driven.

In an embodiment, the voltage setting of the driving waveform may be changed by using the discharge data DD. In this case, n (where n is a natural number less than or equal to i) discharge data among the discharge data DD may be used. For example, the first to n-th discharge data D1 to Dn may be used.

In an embodiment, a voltage V of the driving waveform may be changed to a value obtained by dividing a maximum level of the voltage V by 2^{p} (where p is an integer greater than or equal to 0 and less than or equal to n).

The voltage V may be changed according to a binary value of each of the first to n-th discharge data D1 to Dn. For example, the voltage V may be changed by an n-bit binary number. In this case, only one of the first to n-th discharge data D1 to Dn may be “1”, or all of the first to n-th discharge data D1 to Dn may be “1”.

In an embodiment, in case that only one of the first to n-th discharge data D1 to Dn is “1”, the voltage V may be changed to first to n-th voltages V1 to Vn, respectively, corresponding to discharge data that is “1”. The first to n-th voltages V1 to Vn may correspond to values obtained by dividing the maximum level of the voltage V by 2¹ to 2ⁿ, respectively. For example, in case that the n-th discharge data Dn is “1”, the voltage V may be changed to the n-th voltage Vn, and the n-th voltage Vn may be a value obtained by dividing the maximum level of the voltage V by 2ⁿ.

In an embodiment, in case that all of the first to n-th discharge data D1 to Dn is “1”, the voltage V may be changed to a zeroth voltage V0. In this case, the zeroth voltage V0 may be a value obtained by dividing the maximum level of the voltage V by 2⁰.

For example, in case that the first to twelfth discharge data D1 to D12 are used and the maximum level of the voltage V is 20V, the voltage V may be changed by a 12-bit binary number. For example, in case that a binary number of the first to twelfth discharge data D1 to D12 is “010000000000”, since the second discharge data D2 is “1”, the voltage V may be changed to the second voltage V2. In this case, the second voltage V2 may be 5V, which is a value obtained by dividing 20V, which is the maximum level of the voltage V, by 2² (see FIG. 8).

Accordingly, the voltage setting of the driving waveform of the driving signal DS designated by the third control signal CS3 may be changed to a designated voltage using the discharge data DD.

Referring to FIGS. 1, 2, 9, and 10, the controller CON may apply the second control signal CS2 that changes the voltage setting of the driving waveform to the head HD (S300′).

The controller CON may simultaneously apply the second control signal CS2 and the third control signal CS3 to the head HD. As the second control signal CS2 is applied to the head HD, the head HD may not be driven.

The voltage setting of the driving waveform may be changed by using the discharge data DD. In this case, n discharge data among the discharge data DD may be used.

In an embodiment, the n discharge data may include data units DU. Each of the data units DU may include m (where m is a natural number that is a divisor of n discharge data. For example, a first data unit DU1 of the data units DU may include the first to m-th discharge data D1 to Dm, and a second data unit DU2 of the data units DU may include the (m+1)-th to 2m-th discharge data Dm+1 to D2m.

In an embodiment, each of the data units DU may change a voltage of the driving waveform, and may set a time during which the voltage is applied. In an embodiment, each of the data units DU may change only the time during which the voltage is applied. Since each of the data units DU changes the voltage or the time during which the voltage is applied, the voltage setting of the driving waveform may be changed. Accordingly, a relatively complex driving waveform may be generated.

In an embodiment, the voltage may be changed by using k (where k is a natural number less than m) discharge data included in each of the data units DU. The voltage may be changed according to a binary value of each of the k discharge data. For example, the voltage may be changed by a k-bit binary number. In this case, a level at which the voltage is changed by the k-bit binary number may be preset.

In an embodiment, the voltage in which the time is changed may be designated by using k discharge data included in each of the data units DU. For example, the voltage may be designated by a k-bit binary number. In this case, a level of the voltage designated by the k-bit binary number may be preset.

For example, the voltage may be changed or designated as a first unit voltage VU1 according to a binary value of each of the first to k-th discharge data D1 to Dk using the first to k-th discharge data D1 to Dk. The voltage may be changed or designated as a second unit voltage VU2 according to a binary value of each of the (m+1)-th to (m+k+1)-th discharge data Dm+1 to Dm+k+1 using the (m+1)-th to (m+k+1)-th discharge data Dm+1 to Dm+k+1.

The time during which the voltage is applied may be set or changed using (m−k) discharge data included in each of the data units DU. The time may be set or changed according to a binary value of each of the (m−k) discharge data. For example, the time may be set or changed by a (m−k)-bit binary number. For example, the voltage may be applied for a time obtained by multiplying the (m−k)-bit binary number by about 0.1 μsec.

For example, a first unit time TU1 during which the first unit voltage VU1 is applied may be set or changed according to a binary value of each of the (k+1)-th to m-th discharge data Dk+1 to Dm using the (k+1)-th to m-th discharge data Dk+1 to Dm. The first unit voltage VU1 may be applied during the first unit time TU1.

A second unit time TU2 during which the second unit voltage VU2 is applied may be set or changed according to a binary value of each of the (m+k+2)-th to 2m-th discharge data Dm+k+2 to D2m using the (m+k+2)-th to 2m-th discharge data Dm+k+2 to D2m. The second unit voltage VU2 may be applied during the second unit time TU2.

For example, the first to hundredth discharge data D1 to D100 may be used, and each of the data units DU may include 10 discharge data. For example, 10 data units DU may be used. For example, each of the data units DU may change or designate the voltage by using 2 discharge data, and may set or change the time by using 8 discharge data. The first data unit DU1 may include the first to tenth discharge data D1 to D10, the voltage may be changed or designated as the first unit voltage VU1 by using the first and second discharge data D1 and D2, and the first unit time TU1 may be set or changed by using the third to tenth discharge data D3 to D10. The second data unit DU2 may include the eleventh to twentieth discharge data D11 to D20, the voltage may be changed or designated as the second unit voltage VU2 by using the eleventh and twelfth discharge data D11 and D12, and the second unit time TU2 may be set or changed by using the thirteenth to twentieth discharge data D13 to D20.

In this case, in case that a binary number of the 2 discharge data is “01”, the voltage may be changed or designated as a first set voltage, in case that a binary number of the 2 discharge data is “10”, the voltage may be changed or designated as a second set voltage, and in case that a binary number of the 2 discharge data is “11”, the voltage may be changed or designated as a third set voltage. Levels of each of the first set voltage, the second set voltage, and the third set voltage may be preset. For example, the first set voltage may be about 5V, the second set voltage may be about 10V, and the third set voltage may be about 15V, but the disclosure is not limited thereto.

For example, in case that a binary number of the first and second discharge data D1 and D2 is “01” and a binary number of the third to tenth discharge data D3 to D10 is “00010100”, since the first unit voltage VU1 is the first set voltage, the voltage may be changed or designated as the first set voltage, and the first set voltage may be set or changed to be applied for 2 (=20*0.1) usec. In case that a binary number of the eleventh and twelfth discharge data D11 and D12 are “10” and a binary number of the thirteenth to twentieth discharge data D13 to D20 is “00101000”, since the second unit voltage VU2 is the second set voltage, the voltage may be changed or designated as the second set voltage, and the second set voltage may be set or changed to be applied for 4 (=40*0.1) usec (see FIG. 10).

Accordingly, the voltage setting of the driving waveform of the driving signal DS designated by the third control signal CS3 may be repeatedly changed along the data units DU using the discharge data DD.

FIGS. 7, 8, 9, and 10 illustrate that the first control signal CS1 is applied to the head HD together with the second control signal CS2, but the disclosure is not limited thereto. For another example, while the second control signal CS2 is applied to the head HD, the first control signal CS1 may not be applied to the head HD.

FIGS. 2, 5, 6, 7, 8, 9, and 10 illustrate that each of the first control signal CS1 and the second control signal CS2 may include one data, but the disclosure is not limited thereto. For another example, each of the first control signal CS1 and the second control signal CS2 may include two or more data, and accordingly, the driving waveform may be an analog waveform.

The method of inkjet printing according to an embodiment may be performed using the inkjet printing device 10 including the controller CON that applies the discharge data DD and the control signal CS to the head HD. The control signal CS may include the first control signal CS1 that changes the driving waveform of the driving signal DS, the second control signal CS2 that changes the voltage setting of the driving waveform of the driving signal DS, and the third control signal CS3 that designates the driving signal DS.

In case that it is desirable to change the driving waveform (for example, a temperature change of the head HD, a temperature change of the ink IK, or the like), since the driving waveform may be changed by using the data DT of the controller CON, a separate configuration for changing the driving waveform may not be required. Since it is not desirable to stop printing to change the driving waveform, changing the driving waveform may be performed regardless of a time point, such as in case that printing starts, during printing, in case that printing is completed, in case that changing to a target substrate having a different size, or the like within the spirit and the scope of the disclosure. Therefore, efficiency of printing using the inkjet printing device 10 may be improved.

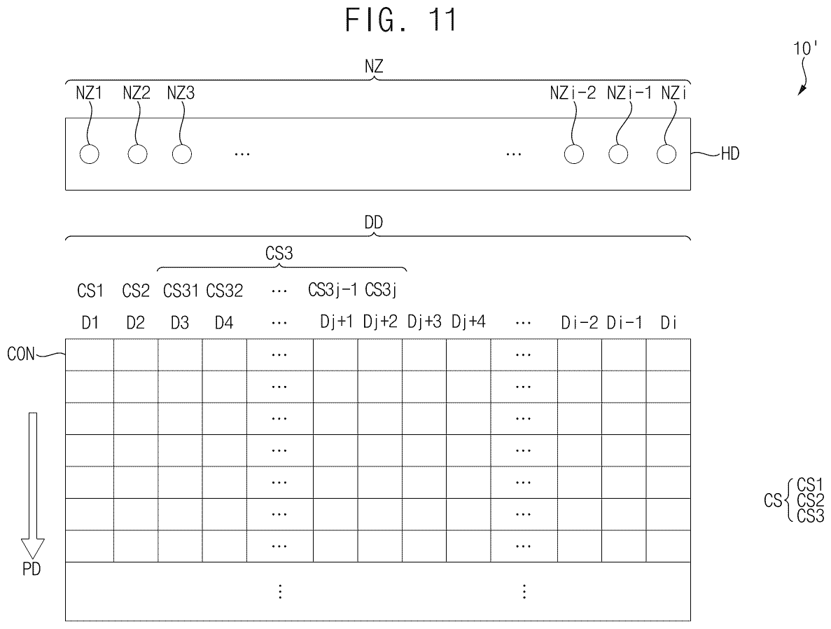

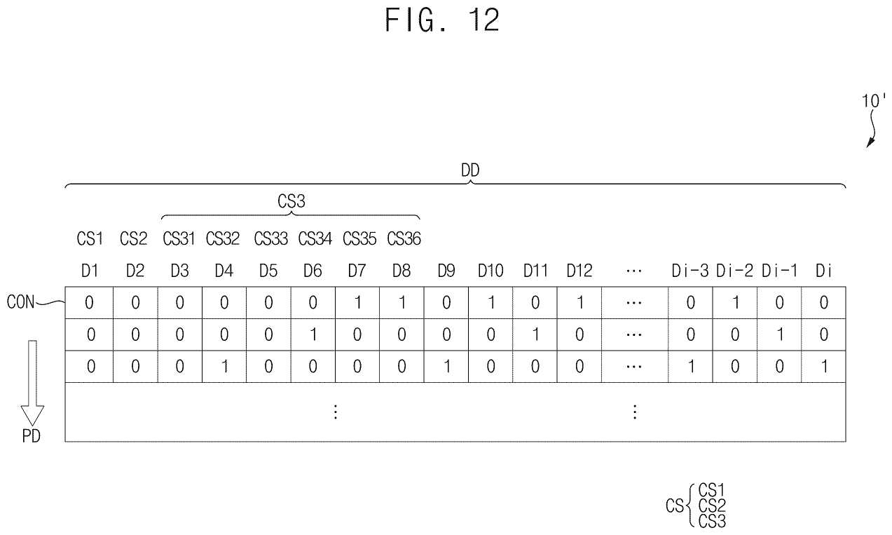

FIGS. 11 and 12 are views illustrating an inkjet printing device according to an embodiment.

The inkjet printing device 10′ described with reference to FIGS. 11 and 12 may be substantially the same as or similar to the inkjet printing device 10 described with reference to FIGS. 1, 2, 3, and 4, except that discharge data DD may include a control signal CS.

The method of inkjet printing described with reference to FIGS. 5, 6, 7, 8, 9, and 10 may be performed using the inkjet printing device 10′ described with reference to FIGS. 11 to 12. Therefore, redundant descriptions may be omitted or simplified.

Referring to FIGS. 11 and 12, the inkjet printing device 10′ may include a head HD and a controller CON. The controller CON may control driving of the head HD.

The head HD may include first to i-th nozzles NZ1 to NZi that respectively discharge ink. The controller CON may include discharge data DD output to the head HD. The discharge data DD may include first to i-th discharge data D1 to Di that control whether the first to i-th nozzles NZ1 to NZi discharge the ink, respectively.

In an embodiment, the discharge data DD may include a control signal CS. The control signal CS may include a first control signal CS1 that changes a driving waveform of a driving signal, a second control signal CS2 that changes a voltage setting of the driving waveform, and a third control signal CS3 that designates the driving signal. The third control signal CS3 may include first to j-th number data CS31 to CS3j.

Some data among the discharge data DD corresponding to the control signal CS may not control ink discharge of the nozzles. For example, the first, second, and third control signals CS1, CS2, and CS3 may correspond to the first to (j+2)-th discharge data D1 to Dj+2, respectively. In this case, the first discharge data D1 may be used as the first control signal CS1, the second discharge data D2 may be used as the second control signal CS2, and the third to (j+2)-th discharge data D3 to Dj+2 may be used as the third control signal CS3. Accordingly, the first to (j+2)-th discharge data D1 to Dj+2 may not control the ink discharge of the first to (j+2)-th nozzles NZ1 to NZj+2. For example, since the first to (j+2)-th discharge data D1 to Dj+2 are always used as the first, second, and third control signals CS1, CS2, and CS3, each of the first to (j+2)-th nozzles NZ1 to NZj+2 may not discharge ink.

In case that the first control signal CS1 is “1” and the second control signal CS2 is “0”, the driving waveform of the driving signal designated by the third control signal CS3 may be changed by using the (j+3)-th to i-th discharge data Dj+3 to Di.

In case that the first control signal CS1 is “0” or “1” and the second control signal CS2 is “1”, the voltage setting of the driving waveform of the driving signal designated by the third control signal CS3 may be changed by using the (j+3)-th to i-th discharge data Dj+3 to Di.

In case that each of the first control signal CS1 and the second control signal CS2 is “0”, the driving signal may be applied to the head HD.

For example, in case that the third control signal CS3 may include the first to sixth number data CS31 to CS36, the driving signal may be designated by a 6-bit binary number.

For example, in case that the third control signal CS3 is “000011” and each of the tenth discharge data D10, the twelfth discharge data D12, and the (i−2)-th discharge data Di−2 is “1”, the ink may be discharged from each of the tenth nozzle NZ10, the twelfth nozzle NZ12, and the (i−2)-th nozzle NZi−2 in a third driving waveform. In a next row along a print direction PD, in case that the third control signal CS3 is “000100” and each of the eleventh discharge data D11 and the (i−1)-th discharge data Di−1 is “1”, the ink may be discharged from each of the eleventh nozzle NZ11 and the (i−1)-th nozzle NZi−1 in a fourth driving waveform. In a next row along the print direction PD, in case that the third control signal CS3 is “010000” and each of the ninth discharge data D9, the (i−3)-th discharge data Di−3, and the i-th discharge data Di is “1”, the ink may be discharged from each of the ninth nozzle NZ9, the (i−3)-th nozzle NZi−3, and the i-th nozzle NZi in a sixteenth driving waveform (see FIG. 12).

The method of inkjet printing according to an embodiment may be performed using the inkjet printing device 10′ including the controller CON that applies the discharge data DD including the control signal CS to the head HD. By using some data of the discharge data DD as the control signal CS, separate additional data for the control signal CS may not be required. For example, since the driving waveform may be changed or the voltage setting of the driving waveform may be changed through the existing discharge data DD, efficiency of printing using the inkjet printing device 10′ may be improved.

The disclosure can be applied to a manufacturing process of various display devices. For example, the disclosure is applicable to a manufacturing process of various display devices such as display devices for vehicles, ships and aircraft, portable communication devices, display devices for exhibition or information transmission, medical display devices, and the like within the spirit and the scope of the disclosure.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the disclosure. Accordingly, all such modifications are intended to be included within the scope of the disclosure and as defined in the claims. Therefore, it is to be understood that the foregoing is illustrative of various embodiments and is not to be construed as limited to the disclosed embodiments, and that modifications to the disclosed embodiments, as well as other embodiments, are intended to be included and within the scope of the appended claims.

What is claimed is:

1. A method of inkjet printing, the method comprising:
applying a driving signal through a controller to a head, the head including a plurality of nozzles;
driving the head in response to the driving signal; and
applying a first control signal that changes a driving waveform of the driving signal to the head through the controller.

2. The method of claim 1, wherein in the applying of the first control signal to the head through the controller,
a third control signal that designates the driving signal is applied to the head through the controller.

3. The method of claim 2, wherein
the controller includes discharge data for each of the plurality of nozzles, and
in the applying of the first control signal to the head through the controller, the driving waveform is changed using the discharge data.

4. The method of claim 3, further comprising:
applying a second control signal that changes a voltage setting of the driving waveform to the head through the controller.

5. The method of claim 4, wherein in the applying of the second control signal to the head through the controller,
the third control signal is applied to the head through the controller.

6. The method of claim 4, wherein in the applying of the second control signal to the head through the controller,
a time during which voltage is applied is changed using the discharge data.

7. The method of claim 4, wherein in the applying of the second control signal to the head through the controller,
the voltage setting of the driving waveform is changed using the discharge data.

8. The method of claim 7, wherein in the applying of the second control signal to the head through the controller,
n discharge data are used among the discharge data, where n is a natural number, and
a voltage of the driving waveform is changed to a value obtained by dividing a maximum level of the voltage by 2^{m}, where m is an integer greater than or equal to 0 and less than or equal to n.

9. The method of claim 7, wherein in the applying of the second control signal to the head through the controller,
n discharge data are used among the discharge data, where n is a natural number,
the n discharge data includes data units each including m discharge data, where m is a natural number that is a divisor of n,
a voltage of the driving waveform is changed using k discharge data included in each of the data units, where k is a natural number less than m, and
a time is set using (m−k) discharge data included in each of the data units.

10. The method of claim 4, wherein the discharge data includes the first control signal, the second control signal, and the third control signal.

11. The method of claim 4, wherein in the applying of the driving signal to the head through the controller and in the driving of the head,
the first control signal and the second control signal are not applied to the head.

12. The method of claim 4, wherein in the applying of the first control signal to the head through the controller and in the applying of the second control signal to the head through the controller,
the driving signal is not applied to the head.

13. An inkjet printing device comprising:
a head including a plurality of nozzles; and
a controller that applies a driving signal or a first control signal that changes a driving waveform of the driving signal to the head.

14. The inkjet printing device of claim 13, wherein the controller simultaneously applies the first control signal and a third control signal that designates the driving signal to the head.

15. The inkjet printing device of claim 14, wherein the controller includes discharge data for each of the plurality of nozzles, and changes the driving waveform using the discharge data.

16. The inkjet printing device of claim 15, wherein the controller applies the driving signal, the first control signal, or a second control signal that changes a voltage setting of the driving waveform to the head.

17. The inkjet printing device of claim 16, wherein the controller simultaneously applies the second control signal and the third control signal to the head.

18. The inkjet printing device of claim 16, wherein the controller changes a time during which voltage is applied using the discharge data.

19. The inkjet printing device of claim 16, wherein the controller changes the voltage setting of the driving waveform using the discharge data.

20. The inkjet printing device of claim 19, wherein the controller uses n discharge data among the discharge data, where n is a natural number, and changes a voltage of the driving waveform to a value obtained by dividing a maximum level of the voltage by 2^{m}, where m is an integer greater than or equal to 0 and less than or equal to n.

21. The inkjet printing device of claim 19, wherein
the controller uses n discharge data among the discharge data, where n is a natural number,
the n discharge data includes data units each including m discharge data, where m is a natural number that is a divisor of n, and
the controller changes a voltage of the driving waveform using k discharge data included in each of the data units, where k is a natural number less than m, and sets a time using (m−k) discharge data included in each of the data units.

22. The inkjet printing device of claim 16, wherein the discharge data includes the first control signal, the second control signal, and the third control signal.
